(19) United States
(12) Patent Application Publication
(10) Pub. No.: US 2009/0016427 A1
(43) Pub. Date: Jan. 15, 2009

(54) DECODING SYSTEM

(76) Inventors: Kazuyuki UCHIDA, Kanagawa (JP); Masato Takemoto, Tokyo (JP)

Correspondence Address: MCDERMOTT WILL & EMERY LLP, 600 13TH STREET, NW, WASHINGTON, DC, 20005-3096, US

(21) Appl. No.: 12/171,685

(22) Filed: Jul. 11, 2008

(30) Foreign Application Priority Data
Jul. 12, 2007 (JP) P.2007-182978

(51) Int. Cl. G10L 19/00; H04N 7/26

(52) U.S. Cl. 375/240; 375/240.25; 704/500; 375/E07.027; 704/E19.001

(57) ABSTRACT

A moving image process adjusting part 103 is provided that obtains decoding information from a moving image decoding part 101 to adjust the process of a moving image processing part 102 in accordance with a decoded state. When the decoding process of next moving image data is completed in the moving image decoding part 101 before the moving image process of current decoded data is finished in the moving image processing part 102, the moving image process adjusting part allows the moving image process to the current decoded data to be finished and the decoding process of subsequent moving image data to be started. Thus, a high frame rate can be realized.

### BACKGROUND OF THE INVENTION

1. Field of the Invention

The present invention relates to a decoding system that expands and reproduces digitally compressed image data or audio data.

2. Description of the Related Art

In recent years, with the progress of multi-media technology, the increase of the capacity of storing media and the intensification of networks, an audio and visual reproduction have been realized by various devices. Further, to meet the large size of an image to be reproduced, a technique is proposed that decoding and noise filtering processes are carried out by a pipeline under the control of the device, or a system which does not have such a throughput of a CPU (Central Processing Unit) as to fully carry out the noise filtering process skips the noise filtering process when the load of the CPU is large (for instance, see Patent Document 1).

Further, when a long processing time is required for a decoding process due to the recent enlargement of the size of an image, since it cannot answer the purpose to carry out decoding and image processes one after another, while the image process is carried out, the decoding process of a next image is carried out by a pipeline process. In that case, in a usual decoding system, the decoding process requires a long or short time depending on frames, however, a moving image process requires a substantially prescribed time. Accordingly, even when the decoding process is completed earlier than the moving image process of a previous frame, a decoded moving image cannot be delivered to a moving image processing part. Thus, the completion of the moving image process of the previous frame is waited for to carry out a next decoding process.

Patent Document 1: JP-A-2007-13315

However, in a usual technique, since whether or not a noise filtering process is carried out is adjusted simply depending on the load of a CPU, for instance, in a system that a decoding process is constantly carried out without an interruption, the load of the decoding process is fixed, so that a noise filtering process cannot be finely adjusted. Therefore, in a system that the decoding process and the noise filtering process are carried out by a pipeline process, since the noise filtering process is carried out for a prescribed time irrespective of a long or short time of the decoding process of one frame. Accordingly, even after the decoding process is completed in a short time, the noise filtering process carried out in parallel therewith is not completed. Thus, a problem arises that the pipeline is disturbed and a frame rate which can be achieved only by the decoding process cannot be achieved.

### SUMMARY OF THE INVENTION

The present invention is devised by considering such circumstances and it is an object of the present invention to provide a decoding system for decoding an encoded moving image or audio in which even when the decoding process of next encoded data is completed before a moving image process or an audio process is completed, the decoding process of subsequent encoded data can be started.

A decoding system of the present invention comprises: a moving image decoding unit that decodes encoded moving image data and outputs a decoded state; a moving image processing unit that carries out a moving image process including a noise filtering process, a rotating process and an enlarging process to the decoded data outputted from the moving image decoding unit; and a moving image process adjusting unit that adjusts the moving image process of the moving image processing unit in accordance with the decoded state outputted from the moving image decoding unit.

According to this structure, when a decoding process of next moving image data is completed before the moving image process is completed, the moving image process can be finished to start a decoding process of moving image data subsequent thereto. Thus, a pipeline is not disturbed and a frame rate that can be achieved only by the decoding process can be achieved.

Further, in the above-described structure, the moving image process adjusting unit allows the moving image processing unit to finish the moving image process when the moving image decoding unit completes the decoding operation of one frame.

According to this structure, when the decoding operation of one frame is completed, the decoding process and the moving image process of a next frame can be immediately carried out.

Further, in the above-described structure, the moving image process adjusting unit allows the moving image processing unit to finish the moving image process when the moving image decoding unit completes the decoding operation of n (n: integer) macro blocks.

According to this structure, when the decoding operation of the n macro blocks is completed, the decoding process and the moving image process of next macro blocks can be immediately carried out and an adjustment finer than that when the decoding operation is carried out for one frame unit can be made.

Further, in the above-described structure, the moving image process adjusting unit thins a moving image processing time of the frame correspondingly to a decoding process time of the moving image decoding unit.

According to this structure, the moving image processing time of the one frame is adjusted so as to be completed until the decoding operation of a next one frame is finished, so that a next decoding process can be carried out.

Further, in the above-described structure, assuming that a decoding time of one frame is k and an average decoding time of the one frame necessary for achieving a frame rate is j, the moving image process adjusting unit thins the moving image process so that the moving image processing time of the frame is 2j-k.

According to this structure, even when the decoding process is early finished to wait for a previous moving image process carried out in parallel with the decoding process, since the moving image process is always finished in an average frame rate time, a next decoding process can be started.

Further, in the above-described structure, the moving image process adjusting unit thins a moving image processing time of n (n: integer) macro blocks correspondingly to a decoding process time of n macro blocks of the moving image decoding unit.

According to this structure, the moving image processing time of the n macro blocks is adjusted so as to be completed until the decoding process of the next macro blocks is finished, so that a next decoding process can be carried out and a control can be more finely carried out.

Further, in the above-described structure, assuming that a decoding time of the n macro blocks is k and an average decoding time of the n macro blocks necessary for achieving a frame rate is j, the moving image process adjusting unit thins the moving image process so that the moving image processing time of the frame is 2j-k.

According to this structure, even when the decoding process is early finished to wait for a previous moving image process carried out in parallel with the decoding process, since the moving image process is always finished in an average frame rate time, a next decoding process can be started.

Further, in the above-described structure, the moving image process adjusting unit calculates a load in accordance with the information of a decoded image during the decoding operation of the moving image decoding unit and adjusts the moving image process of the moving image processing unit on the basis of this result.

According to this structure, the length of the moving image process can be adjusted in accordance with the information of the decoded image.

Further, in the above-described structure, the moving image process adjusting unit adjusts the moving image process of the moving image processing unit in accordance with the type of the frame to be decoded.

According to this structure, the decoding time is predicted in accordance with the type of the frame inputted to a header of data to adjust the length of the moving image process so that a next decoding process can be started.

Further, in the above-described structure, the moving image process adjusting unit adjusts the moving image process of the moving image processing unit in accordance with the color information of the decoded image.

According to this structure, since the part of the color of the skin of a person is important, the moving image process can be adjusted in accordance with the color information of the decoded image.

Further, in the above-described structure, the moving image process adjusting unit adjusts the moving image process of the moving image processing unit in accordance with the quantize value or the movement vector of the decoded image.

According to this structure, the moving image process can be adjusted by thinning or omitting a part in which the moving image process may not be carried out by deciding the feature of the image in accordance with the quantize value or the movement vector.

Further, in the above-described structure, the moving image process adjusting unit has a plurality of patterns for adjusting the moving image process and selects an optimum pattern in accordance with the decoded state outputted from the moving image decoding unit.

According to this structure, when the moving image process is adjusted so as to be thinned, a method for adjusting the moving image process can be selected by, for instance, thinning the moving image process at end parts without thinning the moving image process at an easily marked central part.

Further, a decoding system of the present invention comprises: a moving image decoding unit that decodes encoded moving image data; a moving image processing unit that carries out a moving image process including a noise filtering process, a rotating process and an enlarging process to the decoded data decoded by the moving image decoding unit; and a data temporarily storing unit that is interposed between the moving image decoding unit and the moving image processing unit to temporarily store the decoded data decoded by the moving image decoding unit and input the decoded data to the moving image processing unit in order of decoding the data.

According to this structure, even when a decoding process of a next frame is previously completed before the moving image process is finished, since a decoded result is put in the data temporarily storing unit, a subsequent decoding process can be started.

Further, a decoding system of the present invention comprises: an audio decoding unit that decodes encoded audio data and outputs a decoded state; an audio processing unit that carries out an audio process including a noise filtering process to the decoded data outputted from the audio decoding unit; and an audio process adjusting unit that adjusts the audio process of the audio processing unit in accordance with the decoded state outputted from the audio decoding unit.

According to this structure, since the audio process is adjusted in accordance with the decoded state, when the decoding process of next audio data is completed before the audio process is finished, the audio process can be finished and the decoding process of audio data subsequent thereto can be started. Thus, a pipeline is not disturbed and a frame rate that can be achieved only by the decoding process can be achieved.

Further, in the above-described structure, the audio process adjusting unit allows the audio processing unit to finish the audio process when the audio decoding unit completes the decoding operation of one frame.

According to this structure, when the decoding process of one frame is completed, the decoding process and the audio process of a next frame can be immediately carried out.

Further, in the above-described structure, the audio process adjusting unit thins an audio processing time of the frame correspondingly to a decoding process time of the audio decoding unit.

According to this structure, the audio processing time of the one frame is adjusted so as to be completed until the decoding process of a next one frame is finished, so that a next decoding process can be carried out.

Further, in the above-described structure, assuming that a decoding time of one frame is k and an average decoding time of one frame necessary for achieving a frame rate is j, the audio process adjusting unit thins the audio process so that the audio processing time of the frame is 2j-k.

According to this structure, even when the decoding process is early finished to wait for a previous audio process carried out in parallel with the decoding process, since the audio process is always finished in an average frame rate time, a next decoding process can be started.

Further, a reproducing device of the present invention comprises: a storing unit that stores multiplexed data in which a moving image and an audio are multiplexed; a multiplex separating unit that separates the multiplexed data read from the storing unit into moving image data and audio data; a decoding system that decodes the moving image data; a decoding system that decodes the audio data; a moving image output unit that outputs the moving image obtained from a moving image process by a moving image processing unit of the decoding system that decodes the moving image data of the decoding systems; and an audio output unit that outputs the audio obtained from an audio process by an audio processing unit of the decoding system that decodes the audio data of the decoding systems.

According to this structure, the reproducing device can be realized that can carry out a reproduction with a high frame rate.

Further, a reproducing device of the present invention comprises: a storing unit that stores multiplexed data in which a moving image and an audio are multiplexed; a multiplex separating unit that separates the multiplexed data read from the storing unit into moving image data and audio data; a decoding system that decodes the moving image data; a decoding system that decodes the audio data; a moving image output unit that outputs the moving image obtained from a moving image process by a moving image processing unit of the decoding system that decodes the moving image data of the decoding systems; and an audio output unit that outputs the audio obtained from an audio process by an audio processing unit of the decoding system that decodes the audio data of the decoding systems.

According to this structure, the reproducing device can be realized that can carry out a reproduction with a high frame rate.

Further, a reproducing device of the present invention comprises: a transmitted data receiving unit that receives multiplexed data in which a moving image and an audio are multiplexed through a portable telephone network, a radio LAN network or a wired LAN network; a multiplex separating unit that separates the multiplexed data received by the transmitted data receiving unit into moving image data and audio data; a decoding system that decodes the moving image data; a decoding system that decodes the audio data; a moving image output unit that outputs the moving image obtained from a moving image process by a moving image processing unit of the decoding system that decodes the moving image data of the decoding systems; and an audio output unit that outputs the audio obtained from an audio process by an audio processing unit of the decoding system that decodes the audio data of the decoding systems.

According to this structure, the reproducing device can be realized that can carry out a reproduction with a high frame rate.

Further, a reproducing device of the present invention comprises: a transmitted data receiving unit that receives multiplexed data in which a moving image and an audio are multiplexed through a portable telephone network, a radio LAN network or a wired LAN network; a multiplex separating unit that separates the multiplexed data received by the transmitted data receiving unit into moving image data and audio data; a decoding system that decodes the moving image data; a decoding system that decodes the audio data; a moving image output unit that outputs the moving image obtained from a moving image process by a moving image processing unit of the decoding system that decodes the moving image data of the decoding systems; and an audio output unit that outputs the audio obtained from an audio process by an audio processing unit of the decoding system that decodes the audio data of the decoding systems.

According to this structure, the reproducing device can be realized that can carry out a reproduction with a high frame rate.

According to the present invention, in the decoding system that carries out the moving image process or the audio process, even when the decoding process of next encoded data is completed before the moving image process or the audio process is finished, the decoding process of subsequent encoded data can be started, so that a reproduction of a high frame rate can be realized.

### BRIEF DESCRIPTION OF THE DRAWINGS

FIG. 1 is a block diagram showing the schematic structure of a decoding system according to a first embodiment of the present invention.

FIG. 2 is a sequence diagram showing an operation of the decoding system shown in FIG. 1.

FIG. 3 is a diagram showing macro blocks used for encoding and decoding a moving image.

FIG. 4 is a sequence diagram showing an operation of a decoding system according to a second embodiment.

FIG. 5 is a sequence diagram showing an operation of a decoding system according to a fifth embodiment.

FIG. 6 is a block diagram showing the schematic structure of a decoding system according to a thirteenth embodiment of the present invention.

FIG. 7 is a block diagram showing the schematic structure of a decoding system according to a fourteenth embodiment of the present invention.

FIG. 8 is a block diagram showing the schematic structure of a reproducing device according to a seventeenth embodiment of the present invention.

FIG. 9 is a block diagram showing the schematic structure of a reproducing device according to an eighteenth embodiment of the present invention.

### DESCRIPTION OF THE PREFERRED EMBODIMENTS

Now, preferred embodiments for carrying out the present invention will be described below in detail by referring to the drawings.

### First Embodiment

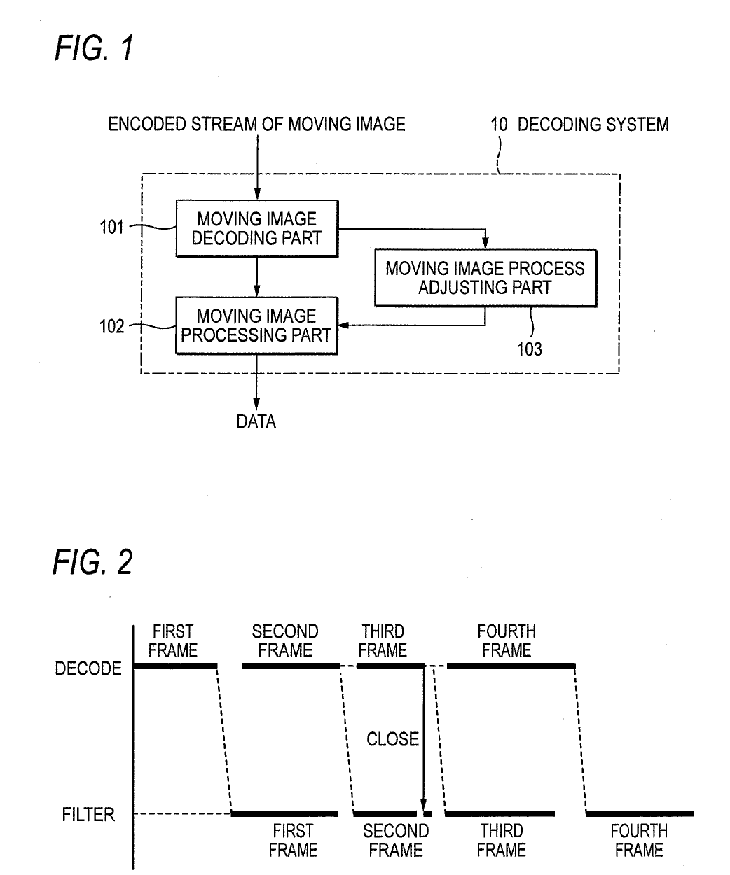

FIG. 1 is a block diagram showing a schematic structure of a decoding system according to a first embodiment of the present invention. In FIG. 1, a decoding system 10 of this embodiment includes a moving image decoding part 101, a moving image processing part 102 and a moving image process adjusting part 103. The moving image decoding part 101 decodes the encoded stream of a moving image. Further, the moving image decoding part 101 supplies decoding information showing a decoded state to the moving image process adjusting part 103. The moving image processing part 102 carries out a moving image process such as a noise filtering process, a rotating process, an enlarging process or the like to data (refer it to as decoded data, hereinafter) decoded in the moving image decoding part 101.

The moving image process adjusting part 103 obtains the decoding information from the moving image decoding part 101 to adjust the process of the moving image processing part 102 in accordance with the decoded state. Here, as the decoding information, for instance, frame information is exemplified. During a decoding process, since a header part to which the frame information is inputted is initially decoded, the frame information is seen so that the moving image process can be adjusted. More specifically described, a predicted time necessary for decoding an I frame or a P frame is estimated in accordance with the type of a frame showing whether the frame information of the header part is put in the P frame (only a difference from a previous frame is inputted) or the I frame (all information is inputted) and the moving image process is adjusted.

When the decoding process (the decoding process of one frame) of next moving image data is completed before the moving image process to moving image data that undergoes the decoding process is finished, the moving image process adjusting part 103 allows the moving image process to be finished and the moving image process to be carried out to the decoded data at the present time. When the decoding process to the present moving image data is completed, the moving image decoding part 101 immediately starts the decoding process to next moving image data. Accordingly, a pipeline is not disturbed and a frame rate that can be achieved only by the decoding process can be achieved.

FIG. 2 is a sequence diagram showing an operation of the decoding system 10 of this embodiment. When the decoding process of the one frame is completed, the moving image process is closed. The decoded data obtained by completing the current process is moved to the moving image processing part 102 and a next stream is read to the moving image decoding part 101. Thus, the decoding process can be carried out without leaving a space between the decoding processes.

As described above, according to the decoding system 10 of this embodiment, the moving image process adjusting part 103 is provided that obtains the decoding information from the moving image decoding part 101 to adjust the process of the moving image processing part 102 in accordance with the decoded state. When the decoding process of the next moving image data is completed in the moving image decoding part 101 before the moving image process of the current decoded data is finished in the moving image processing part 102, the moving image process adjusting part 103 allows the moving image process to the current decoded data to be finished and subsequent moving image data to begin to be decoded. Accordingly, the pipeline is not disturbed and the frame rate that can be achieved only by the decoding process can be achieved.

### Second Embodiment

A decoding system according to a second embodiment of the present invention has a structure the same as that of the decoding system according to the above-described first embodiment, however, is different in the function of a moving image process adjusting part 103 from the first embodiment. That is, the moving image process adjusting part 103 allows a moving image process of a moving image processing part 102 to be finished when the decoding process of n (n: integer) macro blocks is completed in a moving image decoding part 101. Thus, after the decoding process of the n macro blocks is completed, the decoding process and the moving image process of next macro blocks can be immediately carried out so that a finer adjustment can be realized than an adjustment carried out for one frame unit.

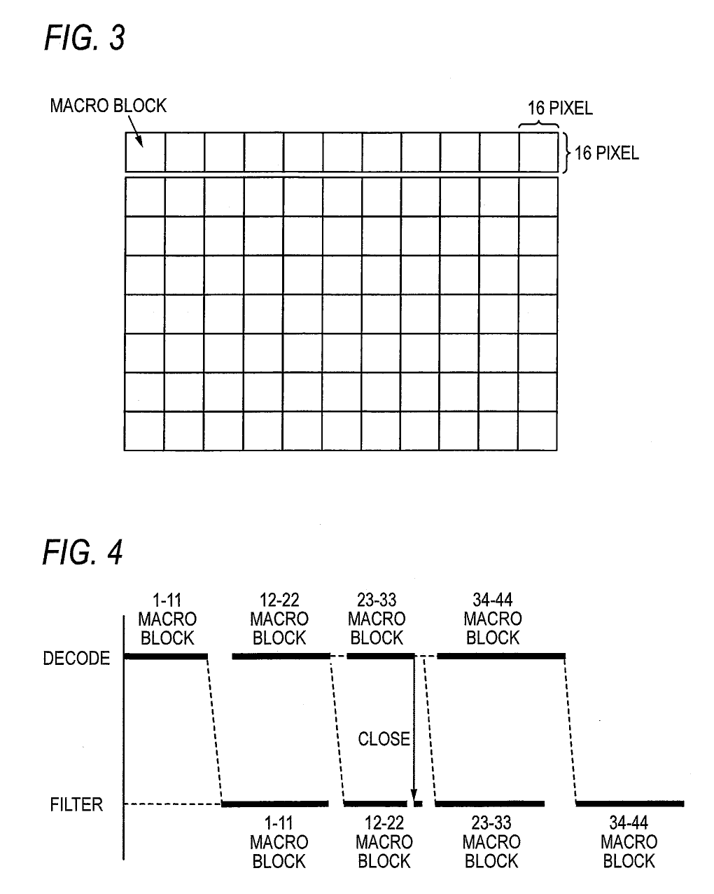

Here, the encoding and decoding processes of a moving image are carried out for a macro block unit as shown in FIG. 3. The macro block is formed with 16 pixels×16 pixels as a unit. When an image size is QCIF (Quarter Common Intermediate Format, 176×144), the image size is formed by 11×8 macro blocks. FIG. 4 is a sequence diagram of the decoding system using the macro blocks. In the case of the QCIF, when the decoding process of the macro blocks of one row (n=11) in a transverse direction is completed, the moving image process is closed, decoded data is moved to the moving image processing part 102 and the moving image decoding part 101 reads a next stream. Thus, the decoding process can be carried out without leaving a space between the decoding processes. Further, an adjustment is made for a macro block unit so that the moving image process can be more finely adjusted.

### Third Embodiment

A decoding system according to a third embodiment of the present invention has a structure the same as that of the decoding system according to the above-described first embodiment, however, is different in the function of a moving image process adjusting part 103 from the first embodiment. That is, the moving image process adjusting part 103 thins a moving image processing time of a frame correspondingly to a decoding process time of a moving image decoding part 101. Thus, the moving image-processing time of the one frame is adjusted so as to be completed until the decoding process of a next one frame is finished, so that a subsequent decoding process can be carried out.

### Fourth Embodiment

A decoding system according to a fourth embodiment of the present invention has a structure the same as that of the decoding system according to the above-described first embodiment, however, is different in the function of a moving image process adjusting part 103 from the first embodiment. That is, assuming that a decoding time of one frame is k and an average decoding time of the one frame necessary for achieving a frame rate is j, the moving image process adjusting part 103 thins the moving image process so that the moving image processing time of the frame is 2j-k. Thus, even when a decoding process is early finished to wait for a previous moving image process carried out in parallel with the decoding process, since the moving image process is always finished in an average frame rate time, a next decoding process can be started.

### Fifth Embodiment

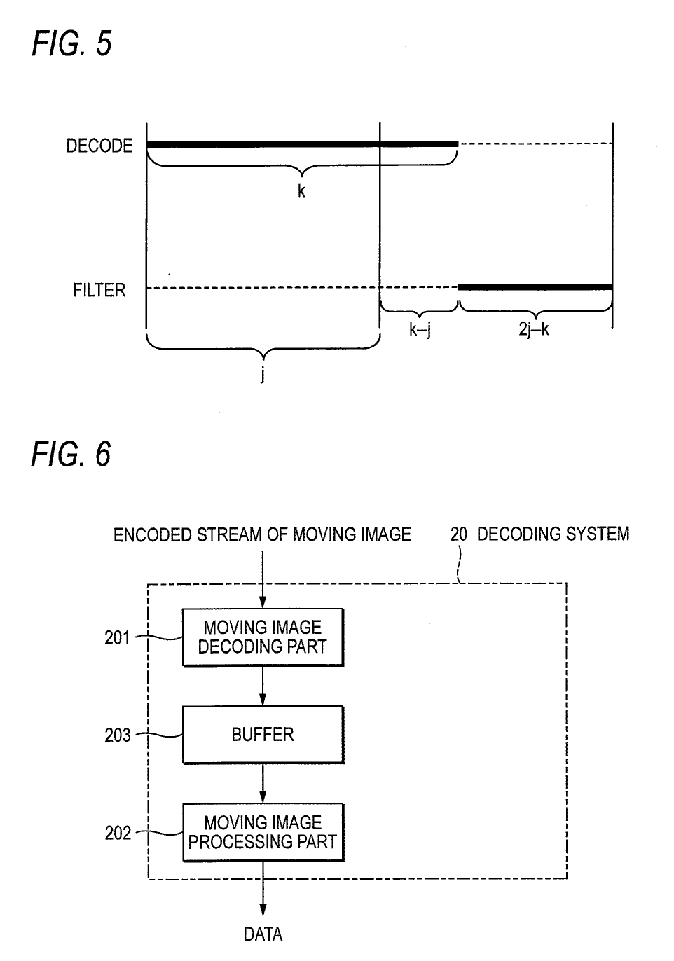

A decoding system according to a fifth embodiment of the present invention has a structure the same as that of the decoding system according to the above-described first embodiment, however, is different in the function of a moving image process adjusting part 103 from the first embodiment. FIG. 5 is a sequence diagram showing an operation of the decoding system of this embodiment. The moving image process adjusting part 103 calculates a necessary average decoding time j of one frame, for instance, 33 ms for one frame when a frame rate is 30 frames per second. When a decoding time finishes in k, the moving image process adjusting part 103 thins a moving image process so that a moving image processing time finishes in 2j-k. Thus, the moving image process can be finished within the average decoding time (that is, the moving image process can be finished without exceeding the average decoding time). Further, the moving image process can be more equally carried out within one screen than a case that the moving image process is closed halfway.

### Sixth Embodiment

A decoding system according to a sixth embodiment of the present invention has a structure the same as that of the decoding system according to the above-described first embodiment, however, is different in the function of a moving image process adjusting part 103 from the first embodiment. That is, the moving image process adjusting part 103 thins a moving image processing time of n macro blocks correspondingly to a decoding process time of n macro blocks of a moving image decoding part 101. Thus, the moving image processing time of the n macro blocks can be adjusted so as to finish until the decoding process of next macro blocks is finished, so that a next decoding process can be carried out and a control can be more finely carried out.

### Seventh Embodiment

A decoding system according to a seventh embodiment of the present invention has a structure the same as that of the decoding system according to the above-described first embodiment, however, is different in the function of a moving image process adjusting part 103 from the first embodiment. That is, assuming that a decoding time of the n macro blocks is k and an average decoding time of the n macro blocks necessary for achieving a frame rate is j, the moving image process adjusting part 103 thins a moving image process so that the moving image processing time of a frame is 2j-k. Thus, even when the decoding process is early finished to wait for a previous moving image process carried out in parallel with the decoding process, since the moving image process is always finished in an average frame rate time, a next decoding process can be started.

### Eighth Embodiment

A decoding system according to an eighth embodiment of the present invention has a structure the same as that of the decoding system according to the above-described first embodiment, however, is different in the function of a moving image process adjusting part 103 from the first embodiment. That is, the moving image process adjusting part 103 calculates a load in accordance with the information of a decoded image during a decoding process of a moving image decoding part 101 and adjusts the moving image process of a moving image processing part 102 on the basis of this result. Thus, the length of the moving image process can be adjusted in accordance with the information of the decoded image.

### Ninth Embodiment

A decoding system according to a ninth embodiment of the present invention has a structure the same as that of the decoding system according to the above-described first embodiment, however, is different in the function of a moving image process adjusting part 103 from the first embodiment. That is, the moving image process adjusting part 103 adjusts the moving image process of a moving image processing part 102 in accordance with the type of a frame to be decoded. Thus, a decoding time is predicted in accordance with the type of the frame inputted to a header of data to adjust the length of the moving image process so that a next decoding process can be started.

### Tenth Embodiment

A decoding system according to a tenth embodiment of the present invention has a structure the same as that of the decoding system according to the above-described first embodiment, however, is different in the function of a moving image process adjusting part 103 from the first embodiment. That is, the moving image process adjusting part 103 adjusts the moving image process of a moving image processing part 102 in accordance with the color information of a decoded image. When a result obtained during a decoding process indicates the color of the skin, since that part is liable to attract a person's attention, the moving image process such as a noise filtering process is carried out. This is a method for adjusting the moving image process in accordance with the color information that since an image having substantially the same color continuing is hardly affected even when the moving image process is not applied thereto, the moving image process is thinned. Since the part of the color of the skin of a person is important, the moving image process can be adjusted in accordance with the color information of the decoded image.

### Eleventh Embodiment

A decoding system according to an eleventh embodiment of the present invention has a structure the same as that of the decoding system according to the above-described first embodiment, however, is different in the function of a moving image process adjusting part 103 from the first embodiment. That is, the moving image process adjusting part 103 adjusts the moving image process of a moving image processing part 102 in accordance with the quantize value of a decoded image. The quantize value is included in frame information of a header part of the decoded image. Since it is understood that when the quantize value is large, the decoded image is rough, and when the decoded value is small, a beautiful picture image is decoded, the moving image process is adjusted in accordance with the value. Thus, the moving image process can be adjusted by thinning or omitting a part in which the moving image process may not be carried out by deciding the feature of the image in accordance with the quantize value or a movement vector. The moving image process can be adjusted in accordance with the movement vector as well as the quantize value. When the movement vector is small, since the image hardly moves, the moving image process is thinned.

### Twelfth Embodiment

A decoding system according to a twelfth embodiment of the present invention has a structure the same as that of the decoding system according to the above-described first embodiment, however, is different in the function of a moving image process adjusting part 103 from the first embodiment. That is, the moving image process adjusting part 103 has a plurality of patterns for adjusting a moving image process and selects an optimum pattern in accordance with a decoded state outputted from a moving image decoding part 101. That is, when the moving image process is thinned, a plurality of patterns for thinning the moving image process are prepared to so as to be selected, for instance, thinning the moving image process in a peripheral part hardly seen by a person without thinning the moving image process in a central part easily seen by a person. Thus, when the moving image process is adjusted so as to be thinned, a method for adjusting the moving image process can be selected by, for instance, thinning the moving image process at end parts without thinning the moving image process at an easily marked central part. Namely, the moving image process can be flexibly thinned.

### Thirteenth Embodiment

FIG. 6 is a block diagram showing a schematic structure of a decoding system according to a thirteenth embodiment of the present invention. In FIG. 6, the decoding system 20 of this embodiment comprises: a moving image decoding part 201; a moving image processing part 202 and a buffer (a data temporarily storing unit) 203. The buffer 203 is interposed between the moving image decoding part 201 and the moving image processing part 202. The buffer 203 is provided so that even if a moving image process is not finished when a decoding process is completed in the moving image decoding part 201, since the buffer 203 stores a decoded result of its size, the moving image decoding part 201 can successively carry out the decoding process.

### Fourteenth Embodiment

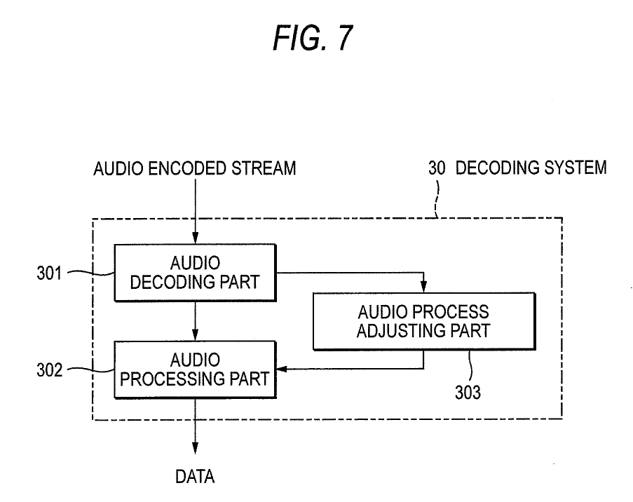

FIG. 7 is a block diagram showing a schematic structure of a decoding system according to a fourteenth embodiment of the present invention. In FIG. 7, the decoding system 30 of this embodiment comprises: an audio decoding part 301; an audio processing part 302 and an audio process adjusting part 303. The audio decoding part 301 decodes an audio encoded stream. Further, the audio decoding-part 301 supplies decoding information to the audio process adjusting part 303. The audio processing part 302 carries out an audio process such as a noise filtering process, an equalizing process or the like to the decoded data outputted from the audio decoding part 301. The audio process adjusting part 303 obtains the decoding information from the audio decoding part 301 to adjust the audio process of the audio processing part 302 in accordance with a decoded state. That is, when the decoding process of next audio data is completed before the audio process to audio data that undergoes a decoding process is finished, the audio process adjusting part 303 allows the audio process to be finished. Specifically, when the decoding process of one frame is completed in the audio decoding part 301, the audio process adjusting part 303 allows the audio process to be finished. When the audio decoding part 301 completes the decoding process to current audio data, the audio decoding part 301 immediately starts the decoding process to next audio data. Accordingly, when the decoding process of the one frame is finished, the decoding process of a next frame and the audio process can be carried out, so that a pipeline is not disturbed and a frame rate that can be achieved only by the decoding process can be achieved.

### Fifteenth Embodiment

A decoding system according to a fifteenth embodiment of the present invention has a structure the same as that of the decoding system according to the above-described fourteenth embodiment however, is different in the function of an audio process adjusting part 303 from the first embodiment. That is, the audio process adjusting part 303 thins an audio processing time of a frame correspondingly to a decoding process time of an audio decoding part 301. Thus, the audio processing time of the one frame is adjusted so as to finish until the decoding process of a next one frame is finished, so that a next decoding process can be carried out.

### Sixteenth Embodiment

A decoding system according to a sixteenth embodiment of the present invention has a structure the same as that of the decoding system according to the above-described fourteenth embodiment, however, is different in the function of an audio process adjusting part 303 from the first embodiment. That is, assuming that a decoding time of one frame is k and an average decoding time of one frame necessary for achieving a frame rate is j, the audio process adjusting part 303 thins an audio process so that an audio processing time of the frame is 2j-k. Thus, even when a decoding process is early finished to wait for a previous audio process carried out in parallel with the decoding process, since the audio process is always finished in an average frame rate time, a next decoding process can be started.

### Seventeenth Embodiment

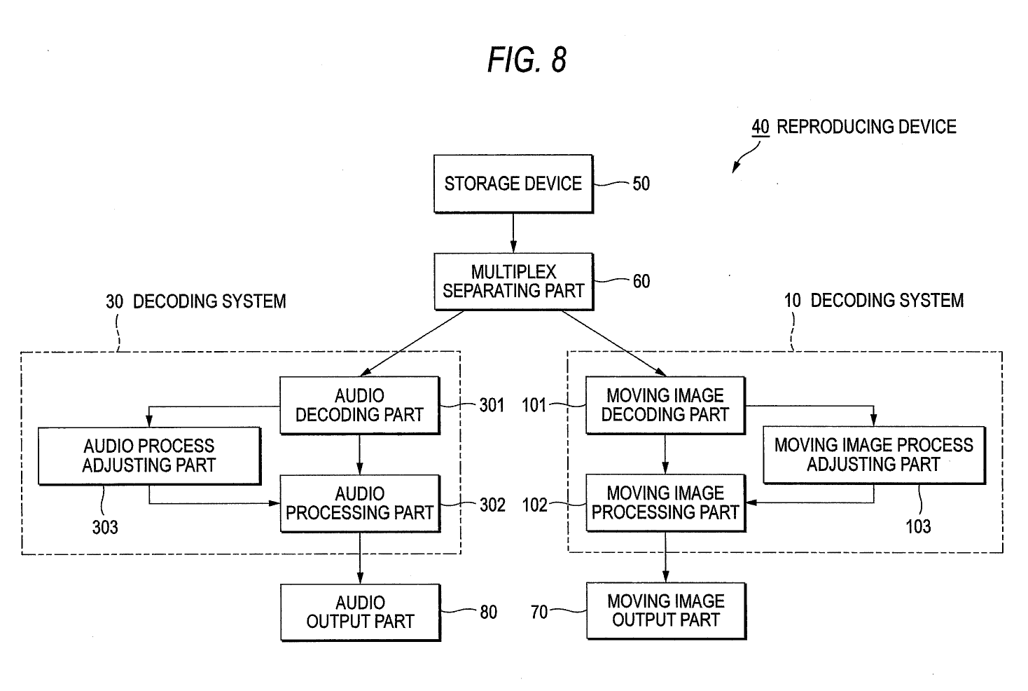

FIG. 8 is a block diagram showing a schematic structure of a reproducing device according to a seventeenth embodiment of the present invention. In FIG. 8, the reproducing device 40 of this embodiment reads and reproduces multiplexed data in which a moving image and an audio are multiplexed from a storage device 50 such as a DVD recorder, a hard disk, a semiconductor storing element, etc. The multiplexed data stored in the storage device 50 is separated in a multiplex separating part 60. Moving image data is decoded in a decoding system 10 to carry out a moving image process and outputted from a moving image output part 70. On the other hand, audio data is decoded in a decoding system 30 to carry out an audio process and outputted from an audio output part 80. Since the reproducing device 40 of this embodiment has the decoding systems 10 and 30, the reproducing device can be realized that can carry out a reproducing process with a high frame rate.

### Eighteenth Embodiment

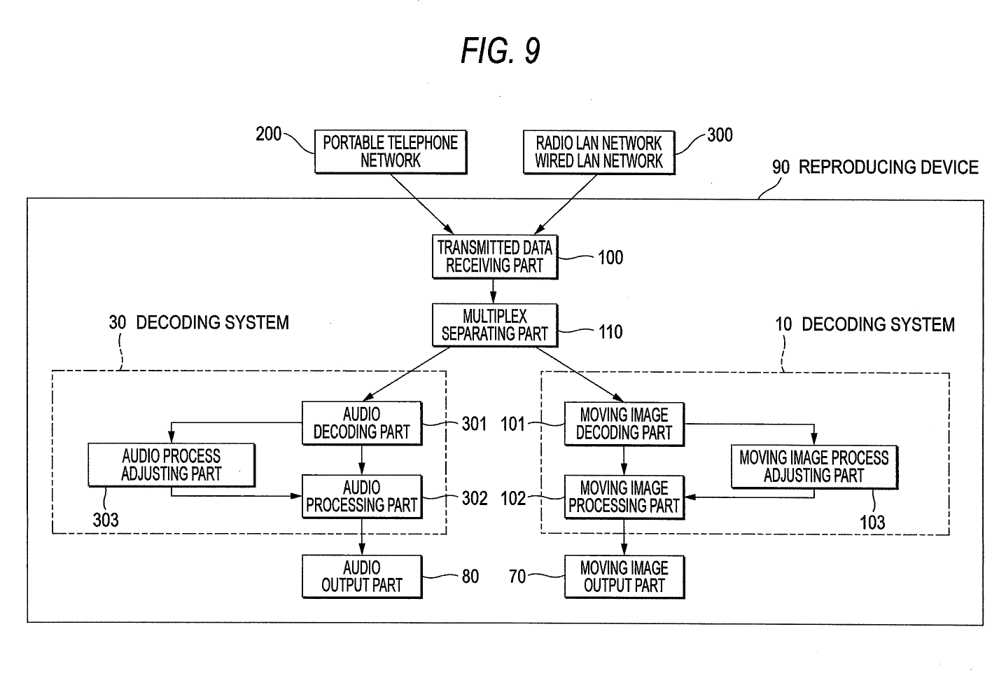

FIG. 9 is a block diagram showing a schematic structure of a reproducing device according to an eighteenth embodiment of the present invention. In FIG. 9, the reproducing device 90 of this embodiment obtains moving image data and audio data from a network such as a portable telephone network 200, a LAN (radio, wired) network 300, etc. and reproduces the moving image data and the audio data. The data from the network is received in a transmitted data receiving part 100. The data is separated into the moving image data and the audio data in a multiplex separating part 110. The moving image data is decoded to carry out a moving image process in a decoding system 10 and outputted from a moving image output part 70. On the other hand, the audio data is decoded in a decoding system 30 to carry out an audio process and outputted from an audio output part 80. Since the reproducing device 90 of this embodiment has the decoding systems 10 and 30, the reproducing device can be realized that can carry out a reproducing process with a high frame rate.

The decoding system of the present invention may be also applied to a case that the moving image process and the audio process in the present invention are divided into several stages and they are divided into pipelines. Further, it is to be understood that a system in which a decoding process, a moving image process and an audio process are carried out one after another without using a pipeline can obtain the same effects by adjusting them with the same arrangement.

The present invention has an effect that even when the decoding process of next encoded data is completed before the moving image process or the audio process is finished, the decoding process of subsequent encoded data can be started, and can be applied to a system for decoding an encoded moving image or audio.

What is claimed is:

1. A decoding system comprising:
a moving image decoding unit that decodes encoded moving image data and outputs a decoded state;
a moving image processing unit that carries out a moving image process including a noise filtering process, a rotating process and an enlarging process to the decoded data outputted from the moving image decoding unit; and
a moving image process adjusting unit that adjusts the moving image process of the moving image processing unit in accordance with the decoded state outputted from the moving image decoding unit.

2. The decoding system according to claim 1, wherein the moving image process adjusting unit allows the moving image processing unit to finish the moving image process when the moving image decoding unit completes the decoding operation of one frame.

3. The decoding system according to claim 1, wherein the moving image process adjusting unit allows the moving image processing unit to finish the moving image process when the moving image decoding unit completes the decoding operation of n (n: integer) macro blocks.

4. The decoding system according to claim 1, wherein the moving image process adjusting unit thins a moving image processing time of the frame correspondingly to a decoding process time of the moving image decoding unit.

5. The decoding system according to claim 4, wherein assuming that a decoding time of one frame is k and an average decoding time of one frame necessary for achieving a frame rate is j, the moving image process adjusting unit thins the moving image processing time of the frame so that the moving image processing time of the frame is 2j-k.

6. The decoding system according to claim 1, wherein the moving image process adjusting unit thins a moving image processing time of n (n: integer) macro blocks correspondingly to a decoding process time of the n macro blocks of the moving image decoding unit.

7. The decoding system according to claim 6, wherein assuming that a decoding time of the n macro blocks is k and an average decoding time of the n macro blocks necessary for achieving a frame rate is j, the moving image process adjusting unit thins the moving image processing time of the frame so that the moving image processing time of the frame is 2j-k.

8. The decoding system according to claim 1, wherein the moving image process adjusting unit calculates a load in accordance with the information of a decoded image during the decoding operation of the moving image decoding unit and adjusts the moving image process of the moving image processing unit on the basis of this result.

9. The decoding system according to claim 1, wherein the moving image process adjusting unit adjusts the moving image process of the moving image processing unit in accordance with the type of the frame to be decoded.

10. The decoding system according to claim 1, wherein the moving image process adjusting unit adjusts the moving image process of the moving image processing unit in accordance with the color information of the decoded image.

11. The decoding system according to claim 1, wherein the moving image process adjusting unit adjusts the moving image process of the moving image processing unit in accordance with the quantize value or the movement vector of the decoded image.

12. The decoding system according to claim 1, wherein the moving image process adjusting unit has a plurality of patterns for adjusting the moving image process and selects an optimum pattern in accordance with the decoded state outputted from the moving image decoding unit.

13. A decoding system comprising:
a moving image decoding unit that decodes encoded moving image data;
a moving image processing unit that carries out a moving image process including a noise filtering process, a rotating process and an enlarging process to the decoded data decoded by the moving image decoding unit; and
a data temporarily storing unit that is interposed between the moving image decoding unit and the moving image processing unit to temporarily store the decoded data decoded by the moving image decoding unit and input the decoded data to the moving image processing unit in order of decoding the data.

14. A decoding system comprising:
an audio decoding unit that decodes encoded audio data and outputs a decoded state;
an audio processing unit that carries out an audio process including a noise filtering process to the decoded data outputted from the audio decoding unit; and
an audio process adjusting unit that adjusts the audio process of the audio processing unit in accordance with the decoded state outputted from the audio decoding unit.

15. The decoding system according to claim 14, wherein the audio process adjusting unit allows the audio processing unit to finish the audio process when the audio decoding unit completes the decoding operation of one frame.

16. The decoding system according to claim 14, wherein the audio process adjusting unit thins an audio processing time of the frame correspondingly to a decoding process time of the audio decoding unit.

17. The decoding system according to claim 16, wherein assuming that a decoding time of one frame is k and an average decoding time of one frame necessary for achieving a frame rate is j, the audio process adjusting unit thins the audio processing time of the frame so that the audio processing time of the frame is 2j-k.

18. A reproducing device comprising:
a storing unit that stores multiplexed data in which a moving image and an audio are multiplexed;
a multiplex separating unit that separates the multiplexed data read from the storing unit into moving image data and audio data;
a decoding system according to any one of claims 1 to 12;
a decoding system according to any one of claims 14 to 17;
a moving image output unit that outputs the moving image obtained from the moving image process by the moving image processing unit of the decoding system for decoding the moving image data of the decoding systems; and
an audio output unit that outputs the audio obtained from the audio process by the audio processing unit of the decoding system for decoding the audio data of the decoding systems.

19. A reproducing device comprising:
a storing unit that stores multiplexed data in which a moving image and an audio are multiplexed;
a multiplex separating unit that separates the multiplexed data read from the storing unit into moving image data and audio data;
a decoding system according to claim 13;
a decoding system according to claim 14;
a moving image output unit that outputs the moving image obtained from the moving image process by the moving image processing unit of the decoding system for decoding the moving image data of the decoding systems; and
an audio output unit that outputs the audio obtained from the audio process by the audio processing unit of the decoding system for decoding the audio data of the decoding systems.

20. A reproducing device comprising:
a transmitted data receiving unit that receives multiplexed data in which a moving image and an audio are multiplexed through a portable telephone network, a radio LAN network or a wired LAN network;
a multiplex separating unit that separates the multiplexed data received by the transmitted data receiving unit into moving image data and audio data;
a decoding system according to claim 12 a decoding system according to claim 14;
a moving image output unit that outputs the moving image obtained from the moving image process by the moving image processing unit of the decoding system for decoding the moving image data of the decoding systems; and
an audio output unit that outputs the audio obtained from the audio process by the audio processing unit of the decoding system for decoding the audio data of the decoding systems.

21. A reproducing device comprising:
a transmitted data receiving unit that receives multiplexed data in which a moving image and an audio are multiplexed through a portable telephone network, a radio LAN network or a wired LAN network;
a multiplex separating unit that separates the multiplexed data received by the transmitted data receiving unit into moving image data and audio data;
a decoding system according to claim 13;
a decoding system according to claim 14;
a moving image output unit that outputs the moving image obtained from the moving image process by the moving image processing unit of the decoding system for decoding the moving image data of the decoding systems; and
an audio output unit that outputs the audio obtained from the audio process by the audio processing unit of the decoding system for decoding the audio data of the decoding systems.
